(19) United States
(12) Patent Application Publication
(10) Pub. No.: US 2019/0389002 A1
(43) Pub. Date: Dec. 26, 2019

(54) Micro-zone laser heating apparatus and method

(71) Applicants: Xiao-dong XIANG, Danville, CA (US); Yingming Yu, Ningbo (CN); Xiao-ping WANG, Shanghai (CN)

(72) Inventors: Xiao-dong XIANG, Danville, CA (US); Yingming Yu, Ningbo (CN); Xiao-ping WANG, Shanghai (CN)

(21) Appl. No.: 16/365,350

(22) Filed: Mar. 26, 2019

Related U.S. Application Data
(60) Provisional application No. 62/648,714, filed on Mar. 27, 2018.

(51) Int. Cl. B23K 26/06; B23K 26/03; B23K 26/064; B23K 26/08; B23K 26/354

(52) U.S. Cl. CPC B23K 26/0626; B23K 26/034; B23K 26/354; B23K 26/083; B23K 26/064

(57) ABSTRACT

The embodiment of the invention discloses a micro-zone laser heating apparatus and method. The micro-zone laser heating apparatus comprises: a laser characteristic determination module, for obtaining first characteristic parameters of the laser required for heating based on the parameters of the current micro-zone to be heated of the sample; a controller, electrically connected to the laser characteristic determination module for generating a control signal based on the first characteristic parameters; a laser output module, electrically connected to the controller for outputting a laser based on the control signal to heat the sample micro-zone to be heated. The micro-zone laser heating apparatus and method provided by the embodiments of the present invention can accurately heat the micro-zone of the high-throughput composite material sample to be heated, while avoiding the phase change of the surrounding area caused by the heating of the material in the adjacent area of the micro-zone to be heated or the component contamination caused by the migration of molecules or atoms inside the sample due to heating. It can be applied to heat treatment or phase change research of low-dimensional and high-density materials.

### FIELD OF THE INVENTION

Embodiments of the present invention relate to the field of material processing technologies, and in particular, to a micro-zone laser heating apparatus and method.

### BACKGROUND

In the 1990's, an advanced material science research method, high-throughput composite material experimental technology, was developed. The technology was inspired by integrated circuit chips and gene chip research, and integrated thousands of different materials on a single small area of a substrate, to form high-throughput composite material chips for research by researchers, greatly reducing consumption of samples and energy.

At present, the phase change research of low-dimensional materials such as film materials is mainly carried out by heating in a conventional heating furnace. Due to the small size of the low-dimensional materials, the phase change rate of the material is fast (the time scale of phase change of some materials is in the nanosecond range), and the phase change research using the conventional heating furnace cannot meet the processing requirements. Simultaneously, with the development of high-throughput composite material chip technology, there are different kinds of materials on a single chip, and the melting points of different components are different. If the sample is placed in a heating furnace at the same time to carry out phase change research, since the spacing between adjacent components is on the order of 100 micrometers, as the temperature rises, the low melting point region on the chip may begin to melt, causing contamination of adjacent component components.

### SUMMARY OF THE INVENTION

The invention provides a micro-zone laser heating apparatus and method, so as to achieve precise heating of micro-zones to be heated on a high-throughput composite material sample, while avoiding the phase change of the surrounding area caused by the heat of the material in the adjacent area of the micro-zone to be heated, and avoiding component contamination caused by the migration of molecules or atoms inside the sample due to heating. It can be applied to heat treatment or phase change research of low-dimensional, high-density materials.

In a first aspect, an embodiment of the present invention provides a micro-zone laser heating apparatus, comprising:

a laser characteristic determination module, for obtaining first characteristic parameters of the laser required for heating based on parameters of the current sample micro-zone to be heated;

a controller, electrically connected to the laser characteristic determination module for generating a control signal based on the first characteristic parameters;

a laser output module, electrically connected to the controller for outputting a laser based on the control signal to heat the sample micro-zone to be heated.

Optionally, the first characteristic parameters of the laser are laser output characteristic parameters.

Optionally, the micro-zone laser heating apparatus further comprises:

a beam detection module, electrically connected to the laser characteristic determination module, for detecting second characteristic parameters of the laser light actually output by the laser output module, and transmitting the second characteristic parameters to the laser characteristic determination module;

the laser characteristic determination module is further configured to correct the control signal based on the second characteristic parameters and the first characteristic parameters.

Optionally, the beam detection module comprises an oscilloscope and a beam spot quality analyzer.

Optionally, the micro-zone laser heating apparatus further comprises:

a temperature detection module, electrically connected to the laser characteristic determination module for detecting an actual temperature of the current micro-zone to be heated, and transmitting the actual temperature to the laser characteristic determination module;

the laser characteristic determination module is further configured to correct the control signal based on an actual temperature of the current micro-zone to be heated.

Optionally, the micro-zone laser heating apparatus further comprises:

a sample support table, for placing the sample;

a sample support table moving module, connected to the sample support table for changing a relative position of the sample support table and the laser output module to sequentially expose the sample micro-zone to be heated to the laser light formed by the laser output module.

Optionally, the micro-zone laser heating apparatus further comprises:

an optical path adjustment module including one or more of a beam expander, a beam reducer, a beam splitter, a reflecting mirror, a filter, a polarizer and an aperture; the optical path adjustment module is located on a propagation path of the laser formed by the laser output module, and is configured to adjust a propagation path of the laser.

In a second aspect, an embodiment of the present invention provides a micro-zone laser heating method, the method comprising the steps of:

providing a sample, the sample includes a current micro-zone to be heated;

obtaining first characteristic parameters of the laser required for heating based on the parameters of the current sample micro-zone to be heated;

generating a control signal based on the first characteristic parameters;

outputting a laser based on the control signal to heat the current sample micro-zone to be heated.

Preferably, after outputting the laser based on the control signal to heat the current sample micro-zone to be heated, the method further comprises:

detecting second characteristic parameters of the laser light actually output by the laser output module, and correcting the control signal based on the second characteristic parameters and the first characteristic parameters.

Optionally, after the outputting the laser based on the control signal to heat the current sample micro-zone to be heated, the method further comprises:

detecting the actual temperature of the current micro-zone to be heated, and transmitting the actual temperature to the laser characteristic determination module, and correcting the control signal based on the actual temperature of the current micro-zone to be heated.

In the embodiment of the present invention, the first characteristic parameters of the laser required for heating is obtained by the laser characteristic determination module based on the parameters of the current sample micro-zone to be heated. The controller generates a control signal based on the first characteristic parameters. The laser output module outputs the laser based on the control signal, so as to accurately heat the sample micro-zone to be heated. It avoids the phase change of the surrounding area caused by the heat of the material in the adjacent area of the micro-zone to be heated or the component contamination caused by the migration of molecules or atoms inside the sample due to heating. It can be applied to heat treatment or phase change research of low-dimensional, high-density materials.

### BRIEF DESCRIPTION OF THE DRAWINGS

FIG. 1 is a schematic structural view of the micro-zone laser heating apparatus in a first embodiment of the present invention;

FIG. 2 is a flow chart of the micro-zone laser heating method in a second embodiment of the present invention;

FIG. 3 is a schematic structural view of the micro-zone laser heating apparatus in a third embodiment of the present invention;

FIG. 4 is a schematic view showing the spatial and temporal curves of the temperature in the spot when the sample is heated by a flat top light and a Gaussian light in the third embodiment of the present invention; and

FIG. 5 is a view showing the relationship between the temperature-time curve of the sample and the applied power coefficient curve φ(r,t) when the sample is heated by the flat top light in the third embodiment of the present invention.

### DETAILED DESCRIPTION

The present invention will be further described in detail below with reference to the accompanying drawings and embodiments. It is understood that the specific embodiments described herein are merely illustrative of the invention and are not intended to limit the invention. It should also be noted that, for ease of description, only some, but not all, of the structures related to the present invention are shown in the drawings.

### Embodiment 1

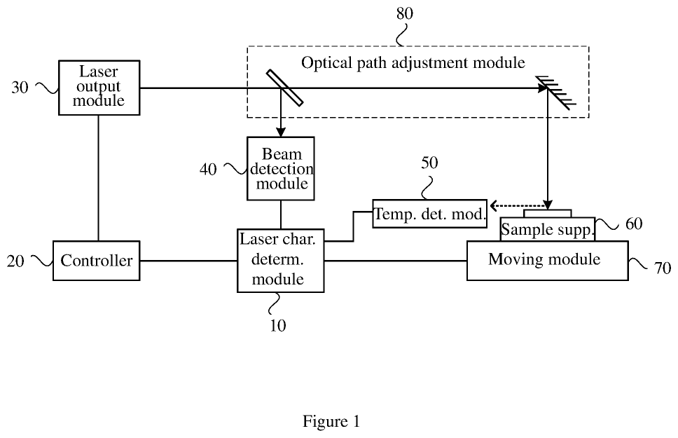

FIG. 1 is a schematic structural view of a micro-zone laser heating apparatus according to a first embodiment of the present invention. The micro-zone laser heating apparatus provided in this embodiment includes:

a laser characteristic determination module 10, for obtaining first characteristic parameters of the laser required for heating based on parameters of the current sample micro-zone to be heated; a controller 20, electrically connected to the laser characteristic determination module 10 for generating a control signal based on the first characteristic parameters; a laser output module 30, electrically connected to the controller 20 for outputting a laser based on the control signal to heat the sample micro-zone to be heated.

It can be understood that the laser characteristics include characteristics such as the wavelength, power, beam shape and the like of the laser. For example, the laser characteristic determination module 10 may be a computer which, based on the shape of the current micro-zone to be heated, the thermal diffusivity, the thermal conductivity, light absorption and reflection characteristics, temperature to be reached by the heating, etc., calculates the first characteristic parameters of the laser required for micro-zone heating. The first characteristic parameters include parameters such as wavelength, power, duration, beam shape and the like of the laser. The controller 20 converts the first characteristic parameters into a control signal, and controls the laser output module 30 to output a laser that meets the requirements of the first characteristic parameters. The laser output module 30 may include a laser and a modulator, and the laser can be one of a solid laser, a liquid laser, a gas laser, a semiconductor laser or a fiber laser. The modulator can be an electro-optic modulator, an acousto-optic modulator, a spatial light modulator, or the like. Those skilled in the art can flexibly choose the above components based on needs. Based on the characteristics of the sample micro-zone to be heated, a suitable laser output module 30 is selected. The laser light required for the heating of the micro-zone is output based on the control signal of the controller 20.

In the micro-zone laser heating apparatus provided by the embodiment of the present invention, the laser characteristic determination module obtains the first characteristic parameters of the laser required for heating based on parameters of the current sample micro-zone to be heated. A controller generates a control signal based on the first characteristic parameters. The laser output module outputs a laser based on the control signal to accurately heat the sample micro-zone to be heated. It avoids the phase change of the surrounding area caused by the heat of the material in the adjacent area of the micro-zone to be heated or the component contamination caused by the migration of molecules or atoms inside the sample due to heating. It can be applied to heat treatment or phase change research of low-dimensional, high-density materials.

Optionally, the first characteristic parameters of the laser are laser output characteristic parameters.

It can be understood that the laser output characteristics include laser output wavelength, output power, duration, beam shape, etc., which are determined based on the material performance parameters of the micro-zone to be heated and the heating process parameters.

Optionally, the micro-zone laser heating apparatus comprising: a beam detection module 40, electrically connected to the laser characteristic determination module 10, for detecting second characteristic parameters of the laser light actually output by the laser output module 30, and transmitting the second characteristic parameters to the laser characteristic determination module 10; the laser characteristic determination module 10 is further configured to correct the control signal based on the second characteristic parameters and the first characteristic parameters.

It can be understood that the second characteristic parameters of the laser include the laser pulse energy, pulse width, frequency, time domain waveform, and spatial distribution shape of the beam etc., actually output by the laser output module 30. The actual output laser of the laser output module 30 may differ from the theoretical values. By comparing the second characteristic parameters with the first characteristic parameters, the control signal is corrected to adjust the output of the laser output module 30, and the reliability of the micro-zone laser heating apparatus can be improved.

Optionally, the beam detection module 40 comprises an oscilloscope and a beam spot quality analyzer.

It can be understood that the oscilloscope and the beam spot quality analyzer are used to detect the second characteristic parameters of output laser from the laser output module 30, and to transmit data of the second characteristic parameters to the laser characteristic determination module 10.

Optionally, the micro-zone laser heating apparatus further comprises: a temperature detection module 50, electrically connected to the laser characteristic determination module 10 for detecting an actual temperature of the current micro-zone to be heated, and transmitting the actual temperature to the laser characteristic determination module 10; the laser characteristic determination module 10 is further configured to correct the control signal based on the actual temperature of the current micro-zone to be heated.

The temperature detection module can be an infrared temperature sensor, a thermocouple temperature sensor, etc., and is flexibly selected based on the temperature range of the micro-zone to be heated. By comparing the actual temperature of the micro-zone to be heated with the theoretical temperature, the temperature error is calculated and corrected by the laser characteristic determination module 10, and the reliability of the micro-zone laser heating apparatus can be improved.

Optionally, the micro-zone laser heating apparatus also comprises: a sample support table 60, for placing the sample; a sample support table moving module 70, connected to the sample support table 60 for changing a relative position of the sample support table 60 and the laser output module 30 to sequentially expose the sample micro-zones to be heated to the laser light formed by the laser output module 30.

It can be understood that a plurality of materials are integrated on the high-throughput composite material chip. In order to heat different micro-zones, a sample support table and a moving module for driving the support table are needed to improve the versatility of the micro-zone laser heating apparatus. Of course, it is also possible to use a fixed support table, and provide a mobile module for the laser output module. Different micro-zone heating is performed by moving the laser output module to change the position of the laser heating spot.

Optionally, the micro-zone laser heating apparatus also comprises: an optical path adjustment module 80, which includes one or more of a beam expander, a beam reducer, beam splitter, reflecting mirror, filter, polarizer and aperture; the optical path adjustment module 80 is located on a propagation path of the laser formed by the laser output module 30, and is configured to adjust a propagation path of the laser.

It can be understood that, in actual application, the laser propagation direction may need to be changed due to the volume limitation of the micro-zone laser heating apparatus, and the optical path may be split to the beam detection module 50, etc. The optical path adjustment module 80 may increase the versatility of the micro-zone laser heating apparatus.

### Embodiment 2

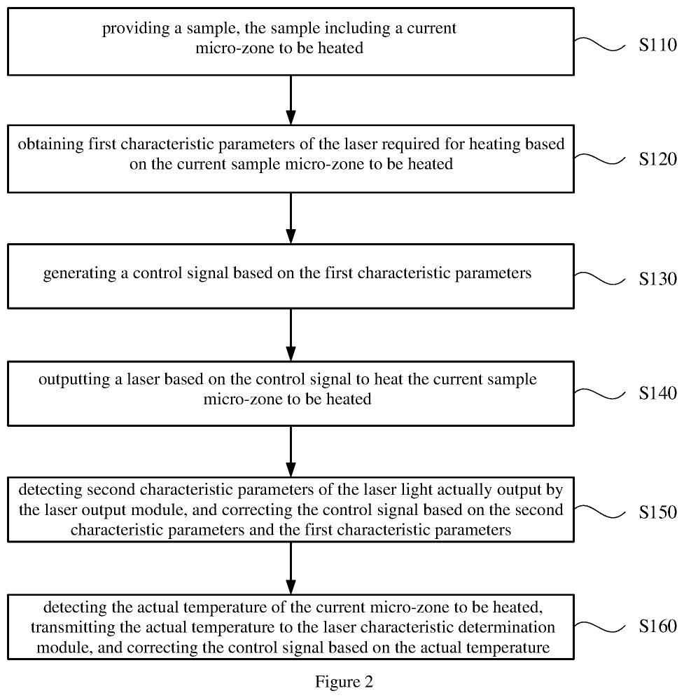

FIG. 2 is a flow chart of a micro-zone laser heating method according to a second embodiment of the present invention. The method provided in this embodiment can be implemented by the micro-zone laser heating apparatus provided in the above embodiment, and the method comprises the following steps:

Step S110, providing a sample, the sample including a current micro-zone to be heated.

Step S120, obtaining first characteristic parameters of the laser required for heating based on parameters of the current sample micro-zone to be heated.

Step S130, generating a control signal based on the first characteristic parameters.

Step S140, outputting a laser based on the control signal to heat the current sample micro-zone to be heated.

It can be understood that the parameters of the current sample micro-zone to be heated include the shape of the micro-zone, the thermal diffusivity, the thermal conductivity, the light absorption and reflection characteristics, the temperature required to be reached by the heating, and the like. The first characteristic parameters include parameters such as the pulse energy of the laser, the pulse width, the frequency, the spatial and temporal distribution of the pulse energy, and the like.

The micro-zone laser heating method provided by the embodiment of the invention firstly obtains first characteristic parameters of the laser required for heating based on parameters of the current sample micro-zone to be heated; generating a control signal based on the first characteristic parameters; then, outputting a laser light based on the control signal, so that the precise heating of the sample micro-zone to be heated is realized. It avoids the phase change of the surrounding area caused by the heat of the material in the adjacent area of the micro-zone to be heated or the component contamination caused by the migration of molecules or atoms inside the sample due to heating. It can be applied to heat treatment or phase change research of low-dimensional, high-density materials.

Optionally, referring to FIG. 2, after step S140, the method further comprises:

Step S150, detecting second characteristic parameters of the laser light actually output by the laser output module, and correcting the control signal based on the second characteristic parameters and the first characteristic parameters.

It can be understood that the second characteristic parameters of the laser includes information such as pulse energy, pulse width, frequency, spatial and temporal distribution of pulse energy, etc. of the laser light actually output by the laser output module. The actual output laser of the laser output module may differ from the theoretical value. By comparing the second characteristic parameters with the first characteristic parameters, the control signal is corrected to adjust the output of the laser output module, and the reliability of the micro-zone laser heating apparatus can be improved.

Optionally, referring to FIG. 2, after step S140, the method further comprises:

Step S160, detecting the actual temperature of the current micro-zone to be heated, and transmitting the actual temperature to the laser characteristic determination module, and correcting the control signal based on the actual temperature of the current micro-zone to be heated.

By comparing the actual temperature of the micro-zone to be heated with the theoretical temperature, the temperature error is calculated and corrected by the laser characteristic determination module, which can improve the reliability of the micro-zone laser heating apparatus.

It should be noted that one of the foregoing steps S150 and S160 may be performed without the other, or step S150 and step S160 may be both performed. If both step S150 and step S160 are performed, in the process of execution, the order of step S150 and step S160 is not limited, and they are both executed after step S140. Performing all steps helps to improve the reliability of the micro-zone laser heating apparatus.

### Embodiment 3

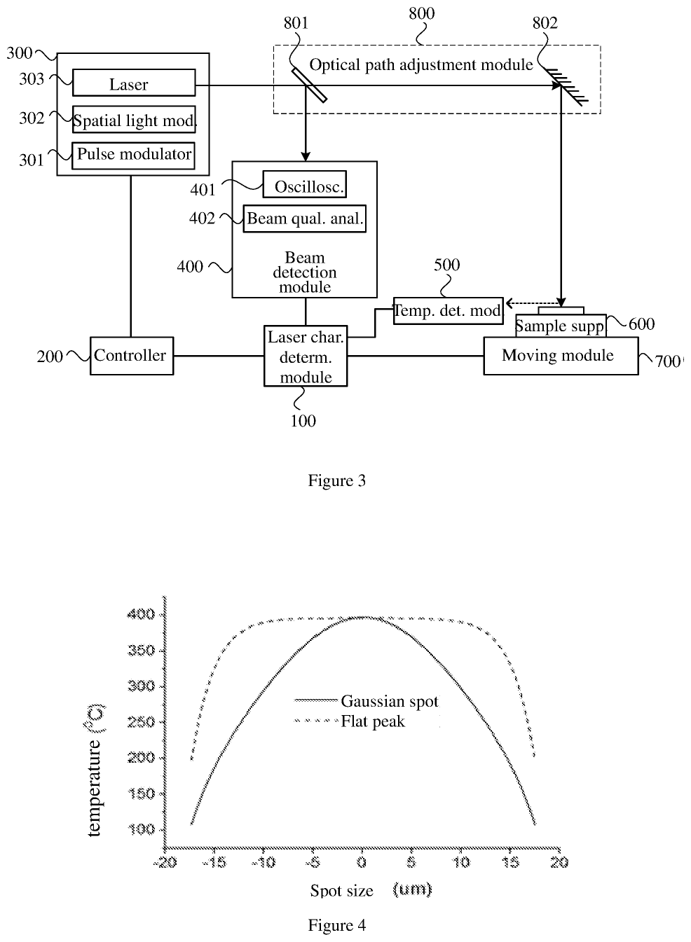

FIG. 3 is a schematic structural view of a micro-zone laser heating apparatus according to a third embodiment of the present invention. This embodiment can provide a specific example based on the above embodiments.

The micro-zone laser heating apparatus provided in this embodiment comprises a laser characteristic determination module 100, a controller 200, a laser output module 300, a beam detection module 400, a temperature detection module 500, a sample support table 600, a sample support table moving module 700, and an optical path adjustment module 800.

Specifically, as shown in FIG. 3, the laser characteristic determination module 100 is a computer. The laser output module 300 includes a time domain pulse modulator 301, a spatial light modulator 302, and a laser 303. The beam detection module 400 includes an oscilloscope 401 and a beam spot quality analyzer 402. The optical path adjustment module 800 includes a beam splitter 801 and a reflecting mirror 802. The laser determination module 100 is electrically connected to the controller 200, the beam detection module 400, the temperature detection module 500, and the sample support table moving module 700, respectively. The beam detection module 400 is located on the reflected light path of the beam splitter 801. The sample is located on the reflected light path of the reflecting mirror 802.

The principle of the micro-zone laser heating apparatus provided by this embodiment is:

Since the longitudinal heat transfer depth of the low-dimensional material is very small relative to the spot size, the heating model can be simplified based on the semi-infinite model, and the calculation model is as follows:

$$\frac{{\partial }^{2} T ( x , t )}{\partial {x}^{2}} + \frac{ϕ ( r , t ) {I}_{0} ( x , t ) η ( 1 - R ) δ {e}^{- δ x}}{k} = \frac{1}{α} \frac{\partial T ( x , t )}{\partial t} \qquad ( 1 )$$

Where α represents the thermal diffusivity of the material; k represents the thermal conductivity of the material; δ represents the optical absorption coefficient of the material; I₀(x,t) represents the laser output power; R represents the material reflectivity (if there is energy through the heated material, the transmission energy loss should be considered); T(x,t) represents the temperature value of the sample at a specific position and at a specific time; η represents the surface loss coefficient of the laser emitted from the laser to the heated material; φ(r,t) represents a coefficient function with respect to time and space.

The material-dependent coefficients α, k, δ, η and the laser output function I₀(x,t) and the preset temperature T(x,t) in equation (1) are input as known quantities into the computer thermal simulation software for calculation. Since the calculation is carried out by the finite element method, the appropriate tolerance should be set based on the process requirements, and the optimal numerical solution of φ(r,t) is finally obtained.

Based on the optimal numerical solution of the coefficient function φ(r,t), the output power of the laser is adjusted and the output laser is spatially shaped and time domain shaped, so that the temperature distribution of the micro-zone to be heated and the temperature change curve with time meet the requirements.

In this embodiment, a 1 μm copper film (SiO₂ substrate) is heated by a pulsed laser with a pulse width of 11 μs is used as an example to describe the working process of the micro-zone laser heating apparatus:

Firstly, based on the thermal properties, the light absorption characteristics, and the heating process requirements of the copper material, the first characteristic parameters (time domain and spatial waveform) of the desired laser are calculated by the computer based on formula (1). Since the copper material has a high light absorption and a low reflectance at a wavelength of 1064 nm, the laser of the embodiment can be a ytterbium-doped aluminum garnet (Nd: YAG) laser. The computer controls the controller 200 to generate a control signal based on the first characteristic parameters of the laser. The time domain pulse modulator 301 and the spatial light modulator 302 adjust the output of the laser 303 based on the control signal such that the output pulse meets the calculated requirements. The second characteristic parameters of the laser output can be observed by the oscilloscope 401 and the beam spot quality analyzer 402, and the result is fed back to the computer. The second characteristic parameters are compared with the first characteristic parameters by the computer. If there is a deviation, the controller 200 outputs a correction signal to cause the time domain pulse modulator 301 or the spatial light modulator 302 to correct the output of the laser 303. After adjusting the spatial and temporal waveforms of the laser, the laser heats the copper film sample after changing the laser path using the reflecting mirror 802. The apparatus can also cooperate with a temperature detection module 500 that quickly feeds back temperature, and compares the actual temperature feedback value to the preset temperature value. If there is a deviation, the actual temperature curve can be compared with the calculation model, and the simulation parameters or models can be corrected. Then, the sample is heated based on the corrected laser energy curve. The temperature of the heating zone is monitored again, until the process requirements are met.

In order to achieve heating of different micro-zones, a sample support table 600 and a sample support table moving module 700 that drives the sample support table 600 to move are provided. The sample support table moving module 700 can be electrically connected to the computer 100 to achieve precise movement to improve the versatility of the micro-zone laser heating apparatus.

FIG. 4 is a graphical representation of the spatial and temporal curves of the temperature within the light spot when the sample is heated with flat top and Gaussian light. In FIG. 4, the laser pulse width τ=11 μs, the spot size d=35 μm, and both the flat top light and the Gaussian light heat the 1 μm copper film to the same maximum temperature.

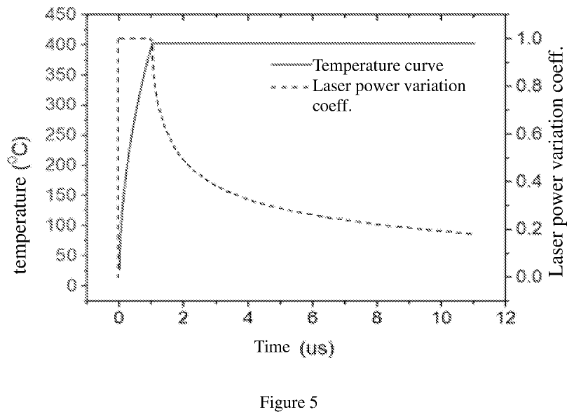

FIG. 5 is a schematic diagram showing the relationship between the sample temperature-time curve and the applied power coefficient curve φ(r,t) when the sample is heated by a flat top light. In FIG. 5, the laser pulse width τ=11 μs, the spot size d=35 μm, and a 1 μm copper film was heated by a flat top spot.

The micro-zone laser heating apparatus provided by the embodiment can simultaneously achieve, to a satisfactory extent, a temperature distribution of the pulsed laser heating zone that is uniform in space and constant over time. It can be applied to heat treatment or phase change research of low-dimensional, high-density materials.

Note that the above are only the preferred embodiments of the present invention and the technical principles applied thereto. Those skilled in the art will appreciate that the present invention is not limited to the specific embodiments described herein. Various obvious changes, modifications, and substitutions will be apparent to those skilled in the art without departing from the scope of the invention. Therefore, although the present invention has been described in detail by the above embodiments, the present invention is not limited to the above embodiments. Other equivalents may be included without departing from the spirit and scope of the invention, and the scope of the invention is determined by the scope of the claims.

What is claimed is:

1. A micro-zone laser heating apparatus, comprising:
a laser characteristic determination module, for obtaining first characteristic parameters of the laser required for heating based on parameters of the current sample micro-zone to be heated;
a controller, electrically connected to the laser characteristic determination module for generating a control signal based on the first characteristic parameters; and
a laser output module, electrically connected to the controller for outputting a laser based on the control signal to heat the sample micro-zone to be heated.

2. The micro-zone laser heating apparatus of claim 1, wherein the first characteristic parameters of the laser are laser output characteristic parameters.

3. The micro-zone laser heating apparatus of claim 1, further comprising:
a beam detection module, electrically connected to the laser characteristic determination module, for detecting second characteristic parameters of the laser light actually output by the laser output module, and transmitting the second characteristic parameters to the laser characteristic determination module;
the laser characteristic determination module is further configured to correct the control signal based on the second characteristic parameters and the first characteristic parameters.

4. The micro-zone laser heating apparatus of claim 3, wherein the beam detection module comprises an oscilloscope and a beam spot quality analyzer.

5. The micro-zone laser heating apparatus of claim 1, further comprising:
a temperature detection module, electrically connected to the laser characteristic determination module for detecting an actual temperature of the current micro-zone to be heated, and transmitting the actual temperature to the laser characteristic determination module;
the laser characteristic determination module is further configured to correct the control signal based on an actual temperature of the current micro-zone to be heated.

6. The micro-zone laser heating apparatus of claim 1, wherein comprising:
a sample support table, for placing the sample;
a sample support table moving module, connected to the sample support table for changing a relative position of the sample support table and the laser output module to sequentially expose the sample micro-zones to be heated to the laser light formed by the laser output module.

7. The micro-zone laser heating apparatus of claim 1, further comprising:
an optical path adjustment module including one or more of a beam expander, beam reducer, beam splitter, reflecting mirror, filter, polarizer and aperture; wherein the optical path adjustment module is located on a propagation path of the laser formed by the laser output module, and is configured to adjust a propagation path of the laser.

8. A micro-zone laser heating method, comprising the steps of:
providing a sample, the sample includes a current micro-zone to be heated;
obtaining first characteristic parameters of the laser required for heating based on the parameters of the current sample micro-zone to be heated;
generating a control signal based on the first characteristic parameters; and
outputting a laser based on the control signal to heat the current sample micro-zone to be heated.

9. The micro-zone laser heating method of claim 8, wherein after the outputting the laser based on the control signal to heat the current sample micro-zone to be heated, the method further comprises:
detecting second characteristic parameters of the laser light actually output by the laser output module, and correcting the control signal based on the second characteristic parameters and the first characteristic parameters.

10. The micro-zone laser heating method of claim 8, wherein after the outputting the laser based on the control signal to heat the current sample micro-zone to be heated, the method further comprises:
detecting the actual temperature of the current micro-zone to be heated, and transmitting the actual temperature to the laser characteristic determination module, and correcting the control signal based on the actual temperature of the current micro-zone to be heated.
